(19) United States
(12) Patent Application Publication
(10) Pub. No.: US 2024/0405215 A1
(43) Pub. Date: Dec. 5, 2024

(54) POSITIVE ACTIVE MATERIAL FOR SECONDARY BATTERY

(71) Applicant: NICHIA CORPORATION, Anan-shi (JP)

(72) Inventors: Toru KOIZUKA, Anan-shi (JP); Shinya HAMAGUCHI, Anan-shi (JP); Yasuhiro YOSHIDA, Naka-gun (JP); Naohiro IKEDA, Anan-shi (JP)

(73) Assignee: NICHIA CORPORATION, Anan-shi (JP)

(21) Appl. No.: 18/731,052

(22) Filed: May 31, 2024

(30) Foreign Application Priority Data
Jun. 1, 2023 (JP) 2023-090614
Feb. 1, 2024 (JP) 2024-014020

(51) Int. Cl. H01M 4/525; C01G 53/00; H01M 4/02

(52) U.S. Cl. CPC H01M 4/525; C01G 53/50; C01P 2002/52; C01P 2002/72; C01P 2006/12; H01M 2004/028

(57) ABSTRACT

A positive active material for a lithium ion battery has a layered structure and contains nickel atoms and cobalt atoms. The positive active material has a ratio of a number of moles of the nickel atom to a total number of moles of metal atoms other than lithium that is 0.7 or more and less than 1. The positive active material has a disorder of lithium element determined by an X-ray diffraction method that is 6.2% or less.

### CROSS-REFERENCE TO RELATED APPLICATION

This application claims priority to Japanese Patent Application No. 2023-90614, filed on Jun. 1, 2023, and Japanese Patent Application No. 2024-14020, filed on Feb. 1, 2024, the disclosure of which is hereby incorporated by reference in its entirety.

### TECHNICAL FIELD

The present disclosure relates to a positive active material for a secondary battery.

### BACKGROUND

A lithium transition metal composite oxide having a layered structure such as lithium cobaltate or lithium nickelate as a positive active material for a nonaqueous electrolyte secondary battery has a high operating potential of about 4 V, and a large capacity can be obtained; therefore, the lithium transition metal composite oxide is widely used as a power source of an electronic device such as a mobile phone, a notebook personal computer, or a digital camera, or a battery for a vehicle. Development of a positive active material for a nonaqueous electrolyte secondary battery exhibiting higher capacity characteristics has been progressed along with high functionality of electronic devices and on-vehicle batteries, and a positive active material using a Ni-containing lithium transition metal oxide in which a ratio of Ni is 70 mol % or more with respect to a total number of moles of metal atoms excluding Li has attracted attention.

Japanese Unexamined Patent Application Publication No. 2021-86830 discloses a positive active material using a Ni-containing lithium transition metal oxide having a high charge capacity in which the ratio of Ni is 70 mol % or more with respect to the total mole of metal atoms excluding Li.

### SUMMARY

When charge-discharge efficiency is the same, since a discharge capacity depends on the charge capacity, a positive active material having a higher charge capacity is required. However, in the lithium transition metal composite oxide having a high nickel content, it has not been clarified what kind of configuration is used to increase the charge capacity. Thus, an object of the present disclosure is to provide a positive active material exhibiting a higher charge capacity when a Ni-containing lithium transition metal oxide in which a ratio of Ni is 70 mol % or more with respect to a total number of moles of metal atoms excluding Li is used.

A first aspect is a positive active material for a lithium ion battery, the positive active material having a layered structure and containing nickel atoms and cobalt atoms. The positive active material has a ratio of moles of the nickel atoms to a total number of moles of metal atoms other than lithium that is 0.7 or more and less than 1, and has a disorder of lithium element determined by an X-ray diffraction method that is 6.2% or less.

According to an aspect of the present disclosure, a positive active material for a secondary battery having a large charge capacity can be provided.

### DETAILED DESCRIPTION OF EMBODIMENTS

In the present specification, in a case where a plurality of substances corresponding to each of the components in the composition are present, the content of each component in the composition, unless otherwise noted, is taken to mean the total amount of these substances present in the composition. Hereinafter, an embodiment of the present disclosure will be described in detail. However, the following embodiment exemplifies a positive active material for a secondary battery for embodying the technical idea of the present disclosure, and the present disclosure is not limited to the positive active material for a secondary battery described below.

### Positive Active Material for Secondary Battery

A positive active material for a secondary battery has a layered structure, contains nickel atoms and cobalt atoms, has a ratio of moles of the nickel atoms to a total number of moles of metal atoms other than lithium that is 0.7 or more and less than 1, and has a disorder of lithium element determined by an X-ray diffraction method that is 6.2% or less.

The present inventor has found that when the ratio of the number of moles of nickel atoms to the total number of moles of metal atoms other than lithium is 0.7 or more and less than 1, a positive active material having a higher charge capacity can be obtained by setting the disorder of lithium element determined by the X-ray diffraction method to 6.2% or less. Here, the disorder of lithium element means a mixing rate of lithium element in a metal site in a crystal structure.

Conventionally, the disorder of nickel element has been used as a concept representing the disorder of metallic elements. The disorder of nickel element in the lithium transition metal composite oxide can be determined by the X-ray diffraction method. An X-ray diffraction spectrum of the lithium transition metal composite oxide is measured by CuKα ray. When a composition model is (Li_{1-d}Ni_{d})(NiₓCo_{y}Mn_{z})O₂(x+y+z=1), structure optimization is performed by Rietveld analysis based on the obtained X-ray diffraction spectrum. The percentage of d calculated as a result of the structure optimization is taken as a value of the disorder of nickel element. The nickel disorder d is a method of simply estimating an occupancy of lithium element in the crystal structure affected by nickel entering a lithium site, and is generally known to be correlated with a charge-discharge capacity and output characteristics.

However, in a high nickel material, since a multiphase change significantly contributes to the charge-discharge capacity, it is necessary to consider not only the occupancy of lithium but also the mixing rate of different elements in the metal site and a defect of the metal site that suppress the multiphase change. An object of the present disclosure is to provide a positive active material exhibiting a high charge capacity by defining a parameter of a lithium disorder comprehensively including the above-described concept and finding that the lithium disorder, which means a mixing rate of a lithium element in a metal site, greatly affects a charge capacity.

The lithium disorder indicates an existence ratio of a lithium element in a transition metal layer of nickel, cobalt, manganese, or the like having a layered structure in the lithium element of a lithium nickel cobalt composite oxide. In a method of calculating a value of the disorder of the lithium element (lithium disorder), the value can be calculated by the following procedure. Based on the obtained X-ray diffraction pattern, the lithium transition metal composite oxide is structurally optimized by Rietveld analysis using Rietan 2000 software with a composition model of (Li₁₋ₓ+Meₓ)(Li_{1-y}Me_{y})O₂(Me represents all elements contained in the positive active material at a ratio of 1 mol % or more among the transition metal and Al in the lithium transition metal composite oxide). Here, the percentage of 1-y calculated as a result of the structure optimization is defined as the lithium disorder (hereinafter also referred to as Li_{dis}). Li_{dis} is correlated with battery characteristics, and the lower Li_{dis} is, the higher the charge capacity is.

Li_{dis} determined by the X-ray diffraction method may be 6.2% or less, preferably 6.0% or less, 5.8% or less, or 5.5% or less, and more preferably 5.0% or less or 4.8% or less, from the viewpoint of the charge capacity.

The disorder of elemental nickel, cobalt, manganese, and aluminum determined by the X-ray diffraction method (hereinafter also referred to as Me_{dis}) is preferably low from the viewpoint of the charge-discharge capacity.

A relational expression between Li_{dis} and Me_{dis} can be expressed as

Li_{dis}=Me_{dis}+(Li_{xrd}−1).

That is, the lower the Me_{dis}, the lower the Li_{dis}; however, since there is a tendency that the larger a Li loading ratio, the lower the Me_{dis}, in this case, the larger the Li_{xrd}. Here, Li_{xrd} is the amount of Li contributing to charge and discharge in the lithium transition metal composite oxide, and is the amount of Li when the amount of oxygen is 2 when optimized as a structure, obtained when XRD measurement and Rietveld analysis are performed on the composition obtained by measurement.

With six rotation axes in a hexagonal system as a c-axis, an a-axis and a b-axis are in a plane perpendicular to the c-axis.

An angle formed by the a and b axes is 120 degrees, and lengths of the a and b axes are the same.

A lattice constant of the a-axis may be 2.870 or more, preferably 2.872 or more, and more preferably 2.874 or more. Within the above range, lithium ions are easily removed and inserted, and the charge capacity is further increased.

The lattice constant of the c-axis may be 14.20 or more, preferably 14.212 or more, and more preferably 14.22 or more. Within the above range, lithium ions are easily removed and inserted, and the charge capacity is further increased.

A 50% particle size D₅₀ of the lithium transition metal composite oxide is, for example, 2 μm or more and 30 μm or less, and preferably 3 μm or more and 25 μm or less. An average particle diameter of the composite oxide is a volume average particle diameter, and is a value at which a volume integrated value from a small particle diameter side in a volume distribution obtained by a laser scattering method is 50%.

A ratio of mole of nickel to the total mole of metals other than lithium in the composition of the lithium transition metal composite oxide contained in the positive active material is 0.7 or more and less than 1. The ratio of the number of moles of nickel to the total mole of metals other than lithium is preferably 0.8 or more, and more preferably 0.81 or more. The ratio of the number of moles of nickel to the total mole of metals other than lithium is preferably 0.95 or less, more preferably 0.92 or less, and particularly preferably 0.9 or less. When the molar ratio of nickel is in the above-described range, it is possible to achieve both the charge-discharge capacity at a high voltage and the cycle characteristics in the secondary battery. The ratio of the number of moles of nickel is determined by, for example, analyzing a metal composition ratio of the positive active material with an inductively coupled plasma emission spectrometer.

A ratio of mole of cobalt to the total mole of metals other than lithium in the composition of the lithium transition metal composite oxide contained in the positive active material is, for example, 0 or more, and is preferably 0.01 or more, and more preferably 0.03 or more from the viewpoint of the output characteristics. The ratio of the number of moles of cobalt to the total mole of metals other than lithium is, for example, 0.5 or less, and is preferably 0.3 or less, and more preferably 0.2 or less from the viewpoint of the charge-discharge capacity.

The composition of the lithium transition metal composite oxide contained in the positive active material may further contain at least one metal element M¹ selected from the group consisting of manganese and aluminum. When the lithium transition metal composite oxide contains the metal element M¹, a ratio of the number of moles of M¹ to the total number of moles of metals other than lithium may be, for example, 0 or more, and is preferably 0.03 or more, more preferably 0.05 or more from the viewpoint of safety. The ratio of the number of moles of M¹ to the total mole of metals other than lithium is, for example, 0.5 or less, and is preferably 0.4 or less, and more preferably 0.3 or less from the viewpoint of the charge-discharge capacity.

When M¹ contains manganese, a ratio of the number of moles of manganese to the total number of moles of metals other than lithium may be more than 0 and 0.2 or less. The ratio is preferably 0.03 or more, more preferably 0.05 or more, and may be 0.15 or less.

When M¹ contains aluminum, the ratio of aluminum to the total mole of metals other than lithium may be more than 0 and 0.10 or less. The ratio is preferably 0.01 or more and may be 0.08 or less and 0.05 or less. M¹ more preferably contains both manganese and aluminum elements.

The composition of the lithium transition metal composite oxide contained in the positive active material may further contain at least one metal element M² selected from the group consisting of boron, sodium, magnesium, silicon, phosphorus, sulfur, potassium, calcium, titanium, vanadium, chromium, zinc, strontium, yttrium, zirconium, niobium, molybdenum, indium, tin, barium, lanthanum, cerium, neodymium, samarium, europium, gadolinium tantalum, tungsten, bismuth, and the like. A ratio of mole of M² to the total mole of metals other than lithium may be, for example, 0 or more, and is preferably 0.005 or more, and particularly preferably 0.01 or more. The ratio of the number of moles of M² to the total mole of metals other than lithium is, for example, 0.1 or less, preferably 0.05 or less, and particularly preferably 0.03 or less.

When M² contains zirconium, a ratio of mole of zirconium to the total mole of metals other than lithium in the lithium transition composite oxide may be 0.001 or more and 0.01 or less, or 0.002 or more and 0.005 or less from the viewpoint of the output characteristics.

A ratio of mole of lithium to the total mole of metals other than lithium in the composition of the lithium transition metal composite oxide contained in the positive active material is, for example, 0.95 or more and 1.5 or less, preferably 1.0 or more and 1.3 or less, and particularly preferably 1.0 or more and 1.1 or less.

When the lithium transition metal composite oxide contained in the positive active material is expressed as a composition, for example, a lithium transition metal composite oxide having a composition represented by the following formula may be used.

LiₚNiₓCo_{y}M¹_{z}M²_{w}O₂

0.95≤p≤1.5, 0.7≤x<1, 0.01≤y<0.3, 0≤z<0.3, 0≤w≤0.1, x+y+z+w≤1, M¹

is at least one selected from the group consisting of Al and Mn, and M² is at least one selected from the group consisting of B, Na, Mg, Si, P, S, K, Ca, Ti, V, Cr, Zn, Sr, Y, Zr, Nb, Mo, In, Sn, Ba, La, Ce, Nd, Sm, Eu, Gd, Ta, W, and Bi.

A specific surface area of the positive active material is, for example, 0.2 m²/g or more, preferably 0.3 m²/g or more. The specific surface area may be 3.0 m²/g or less or 2.0 m²/g or less. When the specific surface area is in the above range, a contact area between the positive active material and the electrolyte is increased, so that the output is easily improved. The specific surface area of the positive active material is measured by a BET method.

The structure of the positive active material of the present application is a trigonal crystal system represented by a space group R-3 m using a symbol of Hermann-Morgan, and a crystallite diameter thereof is a value calculated by the following formula (1) (Scherrer's formula) based on a diffraction peak caused by a (104) plane obtained by the X-ray diffraction method. The X-ray diffraction method can be performed, for example, under the conditions of a tube current of 40 mA and a tube voltage of 40 kV.

$$Dc = K λ / ( β cos θ ) \qquad ( 1 )$$

(Dc: crystallite diameter, K: Scherrer constant (sintered Si (manufactured by Rigaku Corporation) for optical system adjustment was used, and a value at which the crystallite diameter based on the diffraction peak attributed to a (220) plane was 1000 Å was used), λ: wavelength of X-ray source (λ=1.540562 Å in the case of CuKα1), B: half-value width of diffraction line based on sample (calculated from β=By by arc-degree method (B: observed half-value width (by arc-degree method), y=0.9991−0.019505b−2.8205b2+2.878b3−1.0366b4 (b: half-value width (by arc-degree method) based on apparatus system, 0: diffraction angle)

### (Positive Electrode for Nonaqueous Electrolyte Secondary Battery)

A positive electrode for a nonaqueous electrolyte secondary battery includes a current collector and a positive active material layer disposed on the current collector and containing a positive active material for a nonaqueous electrolyte secondary battery produced by the production method, and a nonaqueous electrolyte secondary battery including such an electrode can achieve high output characteristics.

Examples of the material of the current collector include aluminum, nickel, and stainless steel.

The positive active material layer can be formed by applying a positive composite obtained by mixing the positive active material described above, a conductive material, a binder, and the like together with a solvent onto the current collector, and performing a drying treatment, a pressurizing treatment, and the like.

Examples of the conductive material include natural graphite, artificial graphite, and acetylene black. Examples of the binder include polyvinylidene fluoride, polytetrafluoroethylene, and a polyamide acrylic resin.

### Nonaqueous Electrolyte Secondary Battery

A nonaqueous electrolyte secondary battery includes the positive electrode for a nonaqueous electrolyte secondary battery. The nonaqueous electrolyte secondary battery includes a negative electrode for a nonaqueous secondary battery, a nonaqueous electrolyte, a separator, and the like in addition to a positive electrode for a nonaqueous electrolyte secondary battery. As the negative electrode, the nonaqueous electrolyte, the separator, and the like in the nonaqueous electrolyte secondary battery, those for the nonaqueous electrolyte secondary battery described in, for example, JP 2002-075367 A, JP 2011-146390 A, and JP 2006-12433 A can be appropriately selected and used.

### Method of Producing Positive Active Material for Secondary Battery

The method of producing the positive active material may further include a drying step, a particle size regulation step, and the like after a mixing step.

### Method of Producing Lithium Transition Metal Composite Oxide

Lithium transition metal composite oxide particles used in the method of producing a positive active material can be produced, for example, by the following production method. A method of producing a lithium transition metal composite oxide may include: a composite oxide provision step of providing a composite oxide containing nickel and cobalt; and a synthesis step of mixing the composite oxide containing nickel with a lithium compound and performing a heat treatment to obtain a lithium transition metal composite oxide containing lithium and nickel and having a layered structure. The lithium transition metal composite oxide to be produced may contain secondary particles formed by assembling a plurality of primary particles containing the lithium transition metal composite oxide.

In the method of producing a lithium transition metal composite oxide, after the synthesis step, a heat-treated product obtained as necessary may be subjected to a treatment such as grinding, pulverization, or dry sieving and a washing step of bringing the heat-treated product into contact with a solution containing sodium ions and lithium ions may be performed. The treated product after contact with a washing liquid may be subjected to a dehydration treatment, a drying treatment, and the like as necessary. The washing step is a step of removing at least a part of an alkali component of an unreacted raw material in the synthesis step.

In addition, after the synthesis step, a mixing step of mixing with a niobium compound, a tungsten compound, an aluminum compound, or a boron compound after the washing step and the like to obtain a mixture, and a secondary heat treatment step of heat-treating the mixture.

### Composite Oxide Provision Step

In the composite oxide provision step, a composite oxide (hereinafter, also simply referred to as “nickel composite oxide”) containing nickel and cobalt is provided. The nickel composite oxide to be provided may contain secondary particles formed by assembling a plurality of primary particles containing the nickel composite oxide. The nickel composite oxide may be provided by purchase or the like, or may be provided by production by a method of producing a nickel composite oxide described later. Details of the nickel composite oxide to be provided will be described later.

### Synthesis Step

The synthesis step includes mixing the nickel composite oxide to be provided with a lithium compound to obtain a lithium mixture, and heat-treating the lithium mixture to obtain a lithium transition metal composite oxide containing lithium and nickel and having a layered structure. In the synthesis step, lithium contained in the lithium compound may be diffused into the nickel composite oxide to obtain a lithium transition metal composite oxide.

Examples of the method of mixing the nickel composite oxide and the lithium compound include a method of dry-mixing the nickel composite oxide and the lithium compound with a stirring and mixing machine and the like, and a method of preparing a slurry of the nickel composite oxide and wet-mixing the slurry with a mixing machine such as a ball mill. Examples of the lithium compound include lithium hydroxide, lithium nitrate, lithium carbonate, and mixtures thereof.

The ratio (also referred to as a lithium ratio) of the number of moles of lithium to the total mole of metal atoms other than lithium in the lithium mixture may be, for example, 0.9 or more, and is preferably 1 or more, more preferably 1.01 or more, and particularly preferably 1.02 or more. When the lithium ratio is lower than the above-described range, Me_{dis} tends to become high, and as a result, Li_{dis} tends to become high. The lithium ratio may be, for example, 1.2 or less, and is preferably 1.1 or less, more preferably 1.08 or less, and particularly preferably 1.06 or less. When the lithium ratio is higher than the above-described range, Li_{xrd} tends to increase, and as a result, Li_{dis} tends to become high.

In the mixing of the nickel composite oxide and the lithium compound, in addition to the lithium compound, a simple substance, an alloy, or a compound containing a second metal element of at least one second metal element selected from the group consisting of aluminum, magnesium, calcium, titanium, zirconium, niobium, tantalum, molybdenum, tungsten, silicon, tin, bismuth, gallium, yttrium, samarium, erbium, cerium, neodymium, lanthanum, and lutetium may be further mixed. Examples of the compound containing the second metal element include hydroxides, oxides, and carbonates. The second metal element may be at least one selected from the group consisting of zirconium, titanium, magnesium, tantalum, niobium, molybdenum, and tungsten.

In the method of producing a lithium transition metal composite oxide, after the synthesis step, a heat-treated product obtained as necessary may be subjected to a treatment such as grinding, pulverization, or dry sieving.

### Method of Producing Nickel Composite Oxide

The method of producing a nickel composite oxide may include, for example, a first solution provision step of providing a first solution containing nickel ions and, as necessary, cobalt ions and the like, a second solution provision step of providing a second solution containing a complex ion-forming factor, a liquid medium provision step of providing a liquid medium having a pH in a range of 10 or more and 13.5 or less, a crystallization step of obtaining a reaction solution in which the pH is maintained in the range of 10 or more and 13.5 or less while separately and simultaneously supplying the first solution and the second solution to the liquid medium, a composite hydroxide recovery step of obtaining a composite hydroxide containing nickel from the reaction solution, and a composite hydroxide heat treatment step of heat-treating the obtained composite hydroxide to obtain a nickel composite oxide. For details of a method of obtaining such a composite oxide, for example, JP 2003-292322 A, JP 2011-116580 A (US 2012/270107 A), and the like can be referred to.

In the nickel composite oxide, the ratio of the number of moles of nickel to the total mole of metals contained in the nickel composite oxide may be, for example, 0.7 or more and less than 1. The ratio of the number of moles of nickel to the total mole of metal may be preferably 0.8 or more. The ratio of the number of moles of nickel to the total mole of metal may be preferably 0.95 or less and 0.9 or less.

The nickel composite oxide may contain cobalt in its composition. When the nickel composite oxide contains cobalt in its composition, the ratio of the number of moles of cobalt to the total mole of metal contained in the nickel composite oxide may be more than 0 and less than 1. The ratio of the number of moles of cobalt to the total number of moles of metal may be preferably 0.01 or more, 0.02 or more, 0.05 or more, 0.1 or more, or 0.15 or more. The ratio of the number of moles of cobalt to the total mole of metal is preferably 0.6 or less. The ratio of the number of moles of cobalt to the total mole of metal may be 0.4 or less, 0.35 or less, 0.33 or less, 0.3 or less, or 0.25 or less.

The nickel composite oxide may contain at least one of manganese and aluminum in its composition. When the nickel composite oxide contains at least one of manganese and aluminum in its composition, a ratio of the total number of moles of manganese and aluminum to the total number of moles of metal contained in the nickel composite oxide may be, for example, more than 0, preferably 0.01 or more, more preferably 0.05 or more, still more preferably 0.1 or more, and particularly preferably 0.12 or more. The ratio of the total mole of manganese and aluminum to the total mole of metal is, for example, less than 0.3, preferably 0.25 or less. The ratio of the total mole of manganese and aluminum to the total mole of metal may be 0.20 or less, or 0.15 or less.

The nickel composite oxide may contain at least one second metal in its composition. When the nickel composite oxide contains at least one second metal in its composition, a ratio of the total mole of the second metal to the total mole of metals contained in the nickel composite oxide may be, for example, more than 0, 0.001 or more, or 0.003 or more. The ratio of the total mole of the second metal to the total mole of the metal may be, for example, 0.05 or less, 0.02 or less, 0.015 or less, or 0.01 or less.

The nickel composite oxide may have, for example, a composition represented by the following formula (2).

Ni_{q}CoᵣM¹ₛM²ₜO_{2+β} (2)

In the formula (2), M¹ represents at least one of Mn and Al. M² represents at least one selected from the group consisting of Mg, Ca, Ti, Zr, Nb, Ta, Cr, Mo, W, Fe, Cu, Si, Sn, Bi, Ga, Y, Sm, Er, Ce, Nd, La, Cd, and Lu. q, r, s, t, and β satisfy 0.7<q<1, 0<r≤0.4, 0≤s≤0.4, 0≤t≤0.02, −0.1≤β≤1.1, and q+r+s+t=1. Preferably, 0.6≤q≤0.95, 0.02≤r≤0.35, 0.01≤s≤0.35, and 0≤t≤0.015. Furthermore, M² is preferably at least one selected from the group consisting of Zr, Ti, Mg, Ta, Nb, Mo, and W.

The average particle diameter of the nickel composite oxide is, for example, 2 μm or more and 30 μm or less, and preferably 3 μm or more and 25 μm or less. An average particle diameter of the composite oxide is a volume average particle diameter, and is a value at which a volume integrated value from a small particle diameter side in a volume distribution obtained by a laser scattering method is 50%.

In the synthesis step of synthesizing the first particles containing the lithium transition metal composite oxide, a mixture containing lithium obtained by mixing the composite oxide and the lithium compound is heat-treated at a temperature of 550° C. or higher and 1000° C. or lower to obtain a heat-treated product. The obtained heat-treated product has a layered structure and contains a lithium transition metal composite oxide containing nickel.

Examples of the lithium compound to be mixed with the composite oxide include lithium hydroxide, lithium carbonate, and lithium oxide. The particle diameter of the lithium compound used for mixing is, for example, 0.1 μm or more and 100 μm or less, and preferably 2 μm or more and 20 μm or less as a volume average particle diameter.

A ratio of the total mole of lithium to the total mole of metals other than lithium constituting the composite oxide in the mixture may be, for example, 0.95 or more and 1.2 or less, and preferably 1.02 or more and 1.08 or less. The Me_{dis} tends to decrease as the ratio of the total mole of lithium to the total mole of metals other than lithium included in the composite oxide in the mixture increases, and the Li_{xrd} tends to decrease as the ratio of the total mole of lithium to the total mole of metals included in the composite oxide in the mixture decreases. The composite oxide and the lithium compound can be mixed using, for example, a high-speed shearing mixer and the like.

The mixture may further contain metal elements other than lithium and the metal element included in the composite oxide. Examples of other metal elements include Al, Si, Zr, Ti, Mg, Ta, Nb, Mo, and W, and at least one selected from the group consisting of these metal elements is preferable. For example, when the mixture contains W, Nb, and the like as other metal elements, the output characteristics are improved. For example, when the mixture contains Al, Zr, and the like, it is suitable for further improving the cycle characteristics.

For example, when the mixture contains Ti, Si, and the like, it is suitable for further improving the cycle characteristics under a high voltage. When the mixture contains another metal element, a mixture can be obtained by mixing a simple substance of another metal element or a metal compound together with a composite oxide and a lithium compound.

Examples of the metal compound containing other metal elements include oxides, hydroxides, chlorides, nitrides, carbonates, sulfates, nitrates, acetates, and oxalates.

When the mixture contains other metals, a ratio of the total mole of metals included in the composite oxide to the total mole of other metals may be, for example, 1:0.0001 to 1:0.1, and is preferably 1:0.0005 to 1:0.03, or 1:0.001 to 1:0.01.

A heat treatment temperature of the mixture may be, for example, 650° C. or higher and 990° C. or lower, and preferably 700° C. or higher, 730° C. or higher, or 760° C. or higher. The heat treatment temperature may be preferably 960° C. or lower, 940° C. or lower, or 920° C. or lower, and more preferably 880° C. or lower. The mixture may be heat-treated at a single temperature, and is preferably heat-treated at a plurality of temperatures from the viewpoint of the discharge capacity at a high voltage. When the heat treatment is performed at a plurality of temperatures, for example, it is desirable that a first temperature is held for a predetermined time (first heat treatment time), then the temperature is further raised, and a second temperature is held for a predetermined time (second heat treatment time). The first temperature is, for example, 200° C. or higher, preferably 400° C. or higher, and the second temperature may be, for example, 650° C. or higher and 990° C. or lower, preferably 700° C. or higher, 730° C. or higher, or 760° C. or higher. The heat treatment temperature may be preferably 960° C. or lower, 940° C. or lower, or 920° C. or lower, and more preferably 880° C. or lower. The time for the heat treatment is, for example, 0.5 hours to 48 hours, and when the heat treatment is performed at a plurality of temperatures, the time can be 0.2 hours to 47 hours. An atmosphere for the heat treatment may be in the presence of oxygen, and is preferably an atmosphere containing 30 vol % or more and 100 vol % or less of oxygen.

The atmosphere of the heat treatment may be in the air or an atmosphere containing oxygen. The heat treatment can be performed using, for example, a box furnace, a rotary kiln furnace, a pusher furnace, a roller hearth kiln furnace, or the like.

In the composition of the lithium transition metal composite oxide obtained as described above, the ratio of the number of moles of nickel to the total mole of metals other than lithium is 0.7 or more and less than 1, preferably 0.7 or more and 0.95 or less, more preferably 0.75 or more and 0.95 or less, and still more preferably 0.8 or more and 0.95 or less. The lithium transition metal composite oxide may contain cobalt. When the lithium transition metal composite oxide contains cobalt, the ratio of the number of moles of cobalt to the total mole of metals other than lithium may be, for example, more than 0 and 0.3 or less, and is preferably 0.02 or more and 0.2 or less.

The lithium transition metal composite oxide may contain manganese. When the lithium transition metal composite oxide contains manganese, the ratio of the number of moles of manganese to the total mole of metals other than lithium may be, for example, more than 0 and 0.3 or less, and is preferably more than 0 and 0.15 or less, and more preferably 0.01 or more and 0.15 or less. The lithium transition metal composite oxide may contain aluminum. When the lithium transition metal composite oxide contains aluminum, the ratio of the number of moles of aluminum to the total mole of metals other than lithium may be, for example, more than 0 and 0.1 or less, and is preferably more than 0 and 0.05 or less, and more preferably 0.01 or more and 0.04 or less. When the lithium transition metal composite oxide contains at least one of manganese and aluminum, a ratio of the total mole of manganese and aluminum to the total mole of metals other than lithium may be, for example, more than 0 and 0.3 or less, and is preferably more than 0 and 0.25 or less, and more preferably 0.01 or more and 0.15 or less.

The lithium transition metal composite oxide may have, for example, a composition represented by the following formula (3).

$${Li}_{( 1 + p )} {Ni}_{( 1 - x - y - z - w )} {Co}_{x} {Mn}_{y} {Al}_{z} {M}_{w} {O}_{2} \qquad ( 3 )$$

wherein −0.05≤p≤0.2, 0<x+y+z+w≤0.3, 0≤x≤0.3, 0≤y≤0.3, 0≤z≤0.1, and 0≤ w≤0.03 are satisfied. M is at least one element selected from the group consisting of Zr, Ti, Mg, Ta, Nb, Mo, and W.

The volume average particle diameter of the first particles containing the lithium transition metal composite oxide is, for example, 2 μm or more and 30 μm or less, and preferably 3 μm or more and 25 μm or less.

### Washing Step

In the washing step, the first particles containing the lithium transition metal composite oxide are brought into contact with a solution (hereinafter, also referred to as a washing liquid) containing sodium ions to obtain the second particles containing the lithium transition metal composite oxide and the sodium element. The treated product after contact with a washing liquid may be subjected to a dehydration treatment, a drying treatment, and the like as necessary. The washing step is, for example, a step of removing at least a part of the alkali component of the unreacted raw material present in the first particles.

The solution containing sodium ions may contain at least sodium ions and water. The solution containing sodium ions can be prepared, for example, by dissolving a sodium salt in a solvent. Examples of the sodium salt include sodium sulfate and sodium hydroxide, at least one selected from the group consisting of sodium sulfate and sodium hydroxide is preferable, and at least sodium sulfate is more preferably contained. The solvent may contain, for example, at least water, and may contain a water-soluble organic solvent such as an alcohol as necessary in addition to water. The content of sodium ions in the washing solution is, for example, 0.01 mol/L or more and 2.0 mol/L or less, preferably 0.05 mol/L or more and 2.0 mol/L or less, more preferably 0.1 mol/L or more and 1.5 mol/L or less, still more preferably 0.15 mol/L or more and 1.0 mol/L or less, and particularly preferably 0.15 mol/L or more and 0.6 mol/L or less.

The washing liquid may contain metal ions other than sodium as necessary. Examples of metal ions other than sodium include alkali metal ions such as lithium ions and potassium ions, and alkaline earth metal ions such as magnesium ions. When the washing liquid contains metal ions other than sodium, the content thereof is, for example, 0.1 mol/L or less, preferably less than 0.01 mol/L.

A contact temperature between the first particles and the washing liquid is, for example, 5° C. or higher and 60° C. or lower, and preferably 10° C. or higher and 40° C. or lower. The contact time is, for example, 1 minute or more and 2 hours or less, and preferably 5 minutes or more and 30 minutes or less. A liquid amount of the washing liquid used for the contact is, for example, 0.25 times or more and 10 times or less, and preferably 0.5 times or more and 4 times or less the mass of the first particles.

The contact between the first particles and the washing liquid may be performed by adding the first particles to the washing liquid to prepare a slurry. When the contact is performed as a slurry, the solid content concentration of the first particles in the slurry is, for example, 10% by mass or more and 80% by mass or less, and preferably 20% by mass or more and 60% by mass or less. The contact may be performed by passing the washing liquid through the first particles held on a filter, or may be performed by passing the washing liquid through a dehydrated cake obtained by washing the first particles with pure water and the like and dehydrating the first particles. When the first particles are washed with pure water and the like and then the washing liquid is passed through the dehydrated cake obtained by dehydrating the first particles, a total liquid amount of the pure water and the washing liquid to be used is preferably 0.25 times or more and 10 times or less, and more preferably 0.5 times or more and 4 times or less the mass of the first particles. In the solution containing sodium ions (for example, sodium sulfate solution), the solubility of residual alkali (for example, lithium carbonate) is higher than that of pure water, and the residual alkali is easily removed. Thus, from the viewpoint of reducing damage to the lithium transition metal composite oxide, it is preferable to give priority to contact with the washing liquid. It is preferable not to perform washing with pure water.

The second particles obtained in the washing step contain a compound containing sodium in addition to the lithium transition metal composite oxide. The compound containing sodium may be present, for example, at a grain boundary of secondary particles composed of primary particles containing the lithium transition metal composite oxide. The content of the compound containing sodium contained in the second particles is, for example, 100 ppm or more and 1400 ppm or less, preferably 150 ppm or more and 1300 ppm or less, more preferably 150 ppm or more and 1200 ppm or less, still more preferably 200 ppm or more and 1000 ppm or less, and particularly preferably 300 ppm or more and 1000 ppm or less in terms of sodium element. When the content of the compound containing sodium is within the above range, a resistance component during charging and discharging is sufficiently reduced. The content of the compound containing sodium in the second particles can be adjusted by, for example, a sodium ion concentration of the washing liquid, an amount of water adhering to the dehydrated cake, and the like.

The second particles obtained in the washing step may be subjected to a drying treatment. The drying treatment only needs to be able to remove at least a part of moisture adhering to the second particles, and can be performed by heat drying, air drying, reduced-pressure drying, or the like. The drying temperature in the case of heat drying may be a temperature at which moisture contained in the second particles is sufficiently removed. The drying temperature is, for example, 80° C. or higher and 300° C. or lower, and preferably 100° C. or higher and 250° C. or lower. When the drying temperature is within the above range, elution of lithium into attached water can be sufficiently suppressed. It is possible to suppress collapse of the crystal structure on a particle surface and to sufficiently suppress a decrease in charge-discharge capacity. The drying time may be appropriately selected according to the amount of moisture contained in the second particles. The drying time is, for example, 1 hour or more and 10 hours or less. The amount of moisture contained in the second particles after the drying treatment is, for example, 0.2% by mass or less, preferably 0.1% by mass or less.

A degree of washing in the washing step can be confirmed by the lithium content in the second particles, the residual alkali component, the specific surface area, and the like. In general, when the specific surface area of the second particles is small, particle cracking, elution of lithium and elements included in the composite oxide, and the like can be sufficiently suppressed, and the cycle characteristics tend to be further improved. By setting the specific surface area to a certain size, the residual alkali component can be sufficiently reduced. An aqueous solution of a sodium salt such as sodium sulfate as a washing liquid has a higher solubility of a lithium salt than pure water, an aqueous solution of a lithium salt, and the like, so that the amount of liquid required for alkali removal can be reduced. As a result, the specific surface area of the second particles is reduced, and excessive elution of lithium from the second particles can be suppressed.

The specific surface area of the second particles obtained in the washing step may be, for example, 0.5 m²/g or more and 1.0 m²/g or more. The specific surface area may be, for example, 4.0 m²/g or less.

### Mixing Step

In the mixing step, the second particles and a boron compound are mixed to obtain a mixture. The second particles and the boron compound may be mixed in a dry manner or in a wet manner. The mixing can be performed using, for example, a super mixer and the like. In this mixing step, a simple substance, an alloy, or a metal compound of another metal element may be mixed in addition to the boron compound. Examples of other metal elements include Al, Si, Zr, Ti, Mg, Ta, Nb, Mo, and W, and at least one selected from the group consisting of these metal elements is preferable.

The boron compound can be selected from at least one selected from the group consisting of boron oxide, an oxoacid of boron, and an oxoacid salt of boron. More specific examples of the boron compound include lithium tetraborate (Li₂B₄O₇), ammonium pentaborate (NH₄B₅O₈), orthoboric acid (H₃BO₃; so-called normal boric acid), lithium metaborate (LiBO₂), and boron oxide (B₂O₃), and at least one selected from the group consisting of these is preferable, and orthoboric acid is more preferable from the viewpoint of cost.

The boron compound may be mixed with the second particles in a solid state, or may be mixed with the second particles as a solution of the boron compound. When a boron compound in a solid state is used, the volume average particle diameter of the boron compound is, for example, 1 μm or more and 60 μm or less, and preferably 5 μm or more and 30 μm or less.

The content of the boron compound in the mixture is, as a ratio of mole of the boron element to the total mole of metals other than lithium in the lithium transition metal composite oxide, for example, 0.1 mol % or more and 2 mol % or less, preferably 0.1 mol % or more and 1.5 mol % or less, and more preferably 0.1 mol % or more and 1.2 mol % or less.

### Third Heat Treatment Step

In the third heat treatment step, the mixture is heat-treated at, for example, a temperature of 100° C. or higher and 450° C. or lower to obtain a positive active material. The temperature of the heat treatment (third heat treatment temperature) may be 200° C. or higher and 400° C. or lower, preferably 220° C. or higher and 350° C. or lower, and more preferably 250° C. or higher and 350° C. or lower. When the third heat treatment temperature is higher than a drying treatment temperature, the charge-discharge capacity may be further improved. The atmosphere of the third heat treatment may be an oxygen-containing atmosphere or may be in the air. The time for the third heat treatment (third heat treatment time) is, for example, 1 hour or more and 20 hours or less, and preferably 5 hours or more and 10 hours or less. A heat-treated product obtained in the heat treatment step may be subjected to a crushing treatment, a classification treatment, and the like as necessary.

A lithium-deficient region may be formed in the vicinity of the surface of the second particle after the washing step, and desorption/insertion of lithium ions may be inhibited in the lithium-deficient region. However, it is considered that when the boron compound is mixed with the second particles after the washing step and heat-treated, lithium deficiency is compensated, inhibition of lithium ion desorption/insertion is suppressed, and charge-discharge characteristics and the cycle characteristics are improved.

The invention according to the present disclosure may include, for example, the following aspects.

[1] A positive active material for a lithium ion battery, the positive active material having a layered structure and containing nickel atoms and cobalt atoms, wherein the positive active material has a ratio of a number of moles of the nickel atoms to a total number of moles of metal atoms other than lithium that is 0.7 or more and less than 1, and has a disorder of lithium element determined by an X-ray diffraction method that is 6.2% or less.
[2] The positive active material for a lithium ion battery according to [1], wherein the positive active material has a lattice constant of an a-axis in a crystal structure that is 2.874×10⁻¹⁰ m or more.
[3] The positive active material for a lithium ion battery according to [1] or [2], wherein the lattice constant of a c-axis in the crystal structure is 14.212×10⁻¹⁰ m or more.
[4] The positive active material for a lithium ion battery according to any one of [1] to [3], wherein a ratio of a number of moles of the cobalt atoms to the total number of moles of metal atoms other than lithium is 0.05 or more and less than 0.2.
[5] The positive active material for a lithium ion battery according to any one of [1] to [4], wherein a ratio of a number of moles of the nickel atoms to the total number of moles of metal atoms other than lithium is 0.80 or more and less than 0.95.
[6] The positive active material for a lithium ion battery according to any one of [1] to [5], further comprising manganese atoms, wherein a ratio of a number of moles of the manganese atoms to the total number of mole of metal atoms other than lithium is 0.05 or more and less than 0.2.
[7] The positive active material for a lithium ion battery according to any one of [1] to [6], further comprising aluminum atoms, wherein a ratio of a number of mole of the aluminum atoms to the total number of moles of metal atoms other than lithium is 0.01 or more and less than 0.1.
[8] The positive active material for a lithium ion battery according to any one of [1] to [7], wherein a specific surface area of the positive active material is 0.3 m²/g or more and 1.2 m²/g or less.

### EXAMPLES

### Example 1

A nickel composite oxide represented by the composition formula: Ni_{0.895}Co_{0.035}Mn_{0.070} was provided by a coprecipitation method.

### Synthesis Step

Lithium hydroxide, aluminum oxide (III), and zirconium oxide (IV) were mixed with the obtained composite oxide at Li: (Ni+Co+Mn):Al:Zr=1.02:1:0.02:0.0028 (molar ratio) to obtain a lithium mixture. That is, a Li/Me ratio (factor 1) at this time was 1.02. The obtained lithium mixture was heat-treated under an atmosphere having an oxygen volume of 40% (factor 2). In the heat treatment, the first temperature (factor 3) was set to 700° C., the first heat treatment time (factor 4) was set to 3 hours, the second temperature (factor 5) was set to 770° C., and the second heat treatment time (factor 6) was set to 2 hours to obtain a heat-treated product. The resulting heat-treated product was pulverized and subjected to dry sieving to obtain first particles as a lithium transition metal composite oxide represented by the composition formula: Li_{1.02}Ni_{0.875}Co_{0.035}Mn_{0.070}Al_{0.02}Zr_{0.0028}O₂.

### Washing Step

The obtained first particles were added to an aqueous sodium sulfate solution prepared so that the Na concentration (factor 7) was 1 wt % to prepare a slurry having a solid content concentration (factor 8) of 40% by mass. The solid content concentration was determined by the mass of the first particles/(the mass of the first particles+the mass of the washing liquid). This slurry was stirred for 12 minutes, an aqueous lithium sulfate solution adjusted to have a Li concentration (factor 9) of 2 wt % was then added, and the mixture was further stirred for 6 minutes. A total flush time (factor 10) was 0.3 hours. Thereafter, it was dehydrated in a funnel and separated as a cake. The separated cake was dried at a drying temperature (factor 11) of 250° C. for a drying time of 10 hours in the air to obtain second particles.

### Mixing Step

Orthoboric acid in an amount of 1 mol % as a boron compound was added to the total mole of metals other than lithium in the lithium transition metal composite oxide contained in the obtained second particles, and the mixture was mixed and stirred to obtain a mixture.

### Third Heat Treatment Step

The obtained mixture was dried at 350° C. for 5 hours in the air, that is, with the third heat treatment temperature as (factor 12) 350° C. and the third heat treatment time (factor 13) as 5 hours, and a positive active material according to Example 1 containing 1 mol % of a boron compound and represented by the composition Li_{1.02}Ni_{0.875}Co_{0.035}Mn_{0.07}Al_{0.020}Zr_{0.0028} was obtained.

### Examples 2 to 9 and Comparative Examples 1 to 5

A nickel composite oxide represented by the composition formula: Ni_{0.895}Co_{0.035}Mn_{0.070} was provided by a coprecipitation method. A positive active material was obtained in the same manner as in Example 1 except that the factors 1 to 13 were changed as shown in Table 1.

### Examples 10 and 11 and Comparative Example 6

A nickel composite oxide represented by the composition formula: Ni_{0.895}Co_{0.035}Mn_{0.070} was provided by a coprecipitation method. A positive active material containing a lithium transition metal composite oxide was obtained in the same manner as in Example 1 except that the mixing step and the second heat treatment were not performed and the factors 1 to 11 were changed as shown in Table 1.

### Example 12

A nickel composite oxide represented by the composition formula: Ni_{0.835}Co_{0.052}Mn_{0.113} was provided by the coprecipitation method. Composition Li_{1.06}Ni_{0.815}Co_{0.050}Mn_{0.115}Al_{0.020}Zr_{0.005} of a positive active material containing a lithium transition metal composite oxide was obtained in the same manner as in Example 1 except that the factors 1 to 13 were each changed as shown in Table 1.

### Example 13, Comparative Example 7, and Comparative Example 8

A nickel composite oxide represented by the composition formula: Ni_{0.823}Co_{0.051}Mn_{0.126} was provided by the coprecipitation method. Except that in the mixture in the synthesis step, the mixture was mixed such that the ratio of metals other than lithium was (Ni+Co+Mn): Al:Zr=1:0.01:0.005 (molar ratio), and the factors 1 to 13 were each changed as shown in Table 1, the same procedure as in Example 12 was carried out to obtain a positive active material containing a lithium transition metal composite oxide, the composition Li_{1.08}Ni_{0.815}Co_{0.050}Mn_{0.125}Al_{0.010}Zr_{0.005} of Example 13, and the composition Li_{1.12}Ni_{0.815}Co_{0.050}Mn_{0.125}Al_{0.010}Zr_{0.005} of Comparative Examples 7 and 8.

| | | | | | | Factor 6 | |
|---|---|---|---|---|---|---|---|
| | | | | | | second | |
| | | Factor 2 | Factor 3 | Factor 4 | | heat | Factor 7 |
| | Factor 1 | oxygen | first | first heat | Factor 5 | treatment | Na |
| | loading | volume | temperature | treatment | temperature | time | concentration |
| | Li/Me | (%) | (° C.) | (hr) | (° C.) | (hr) | (wt %) |
| Example 1 | 1.02 | 40 | 700 | 3.0 | 770 | 2 | 1 |
| Example 2 | 1.02 | 40 | 700 | 1.0 | 770 | 6 | 1 |
| Example 3 | 1.02 | 40 | 700 | 1.0 | 770 | 6 | 0 |
| Example 4 | 1.02 | 100 | 200 | 5.0 | 770 | 6 | 1 |
| Example 5 | 1.02 | 70 | 200 | 5.0 | 770 | 2 | 0 |
| Example 6 | 1.06 | 70 | 450 | 3.0 | 750 | 4 | 0.5 |
| Example 7 | 1.1 | 40 | 200 | 1.0 | 770 | 2 | 1 |
| Example 8 | 1.1 | 100 | 200 | 5.0 | 770 | 6 | 1 |
| Example 9 | 1.06 | 100 | 200 | 1.0 | 770 | 6 | 1 |
| Example 10 | 1.02 | 40 | 200 | 5.0 | 770 | 2 | 0 |
| Example 11 | 1.02 | 40 | 200 | 1.0 | 770 | 6 | 0.5 |
| Example 12 | 1.06 | 60 | 450 | 3.2 | 793 | 4.2 | 1 |
| Example 13 | 1.08 | 60 | 450 | 3.2 | 785 | 4.2 | 1 |
| Comparative | 1.02 | 40 | 700 | 1.0 | 730 | 2 | 0 |
| Example 1 | | | | | | | |
| Comparative | 1.1 | 40 | 700 | 5.0 | 770 | 2 | 1 |
| Example 2 | | | | | | | |
| Comparative | 1.1 | 40 | 200 | 5.0 | 750 | 6 | 0 |
| Example 3 | | | | | | | |
| Comparative | 1.1 | 40 | 200 | 1.0 | 730 | 6 | 0 |
| Example 4 | | | | | | | |
| Comparative | 1.1 | 100 | 200 | 5.0 | 770 | 2 | 1 |
| Example 5 | | | | | | | |
| Comparative | 1.1 | 70 | 700 | 1.0 | 730 | 6 | 1 |
| Example 6 | | | | | | | |
| Comparative | 1.12 | 60 | 450 | 3.2 | 772 | 4.2 | 1 |
| Example 7 | | | | | | | |
| Comparative | 1.12 | 60 | 450 | 3.2 | 782 | 4.2 | 1 |
| Example 8 | | | | | | | |

| | | | Factor 10 | | Factor 12 | Factor 13 |
|---|---|---|---|---|---|---|
| | Factor 8 | Factor 9 | water | Factor 11 | third heat | third heat |
| | solid content | Li | flush | drying | treatment | treatment |
| | concentration | concentration | time | temperature | temperature | time |
| | (wt %) | (wt %) | (hr) | (° C.) | (° C.) | (hr) |
| Example 1 | 40 | 2 | 0.3 | 250 | 350 | 5 |
| Example 2 | 60 | 0 | 0.1 | 250 | 350 | 5 |
| Example 3 | 60 | 2 | 0.3 | 150 | 350 | 10 |
| Example 4 | 40 | 2 | 0.1 | 250 | 350 | 5 |
| Example 5 | 40 | 0 | 0.3 | 150 | 350 | 10 |
| Example 6 | 50 | 1 | 0.2 | 200 | 275 | 7.5 |
| Example 7 | 60 | 2 | 0.3 | 150 | 350 | 7.5 |
| Example 8 | 40 | 0 | 0.1 | 150 | 350 | 10 |
| Example 9 | 60 | 0 | 0.3 | 150 | 200 | 10 |
| Example 10 | 50 | 2 | 0.3 | 150 | — | — |
| Example 11 | 40 | 0 | 0.3 | 250 | — | — |
| Example 12 | 60 | 4 | 0.5 | 250 | 300 | 10 |
| Example 13 | 60 | 4 | 0.5 | 250 | 300 | 10 |
| Comparative | 60 | 2 | 0.3 | 250 | 200 | 5 |
| Example 1 | | | | | | |
| Comparative | 60 | 0 | 0.3 | 250 | 200 | 10 |
| Example 2 | | | | | | |
| Comparative | 40 | 2 | 0.3 | 250 | 200 | 10 |
| Example 3 | | | | | | |
| Comparative | 60 | 1 | 0.1 | 250 | 200 | 5 |
| Example 4 | | | | | | |
| Comparative | 60 | 2 | 0.1 | 250 | 200 | 5 |
| Example 5 | | | | | | |
| Comparative | 60 | 2 | 0.1 | 250 | — | — |
| Example 6 | | | | | | |
| Comparative | 60 | 4 | 0.5 | 250 | 300 | 10 |
| Example 7 | | | | | | |
| Comparative | 60 | 4 | 0.5 | 250 | 300 | 10 |
| Example 8 | | | | | | |

### (Description of Apparatus)

Hereinafter, the subject matter of the present disclosure will be specifically described based on examples. However, the present disclosure is not limited to these examples. As the volume average particle diameter, a value (D₅₀) at which the volume integrated value from the small particle diameter side in a volume particle size distribution obtained by the laser scattering method was 50% was used. Specifically, the volume average particle diameter was measured using a laser diffraction particle diameter distribution apparatus (MicrotracBEL MT 3300 EXII). The specific surface area was measured by a gas adsorption method (one-point method) using nitrogen gas using a BET specific surface area measuring apparatus (manufactured by Mountech Co., Ltd.: Macsorb). Calculation was performed by Rietveld analysis from a diffraction pattern measured using an X-ray diffraction analyzer (XRD). For the measurement, an X-ray diffraction pattern was measured using an X-ray diffractometer (SmartLab manufactured by Rigaku Corporation). As an X-ray source, CuKα rays having wavelengths of 0.15405 nm and 0.15444 nm were used, and RIETAN-2000 was used for Rietveld analysis.

The value of the disorder of elemental nickel (Ni disorder amount) was determined by the X-ray diffraction method according to the following procedure. For the obtained lithium transition metal composite oxide particles, based on the obtained X-ray diffraction spectrum, a composition model was Li_{1-d}NidMeO₂ (Me was a transition metal other than nickel in the lithium transition metal composite oxide), and for the lithium transition metal composite oxide, structure optimization was performed by Rietveld analysis using Rietan 2000 software. The percentage of d calculated as a result of the structure optimization was defined as the Ni disorder amount (Ni_{dis}). The results are shown in Table 2.

### (Crystallinity)

The obtained positive active material was subjected to the X-ray diffraction method. In the X-ray diffraction method, an X-ray diffractometer (Ultima manufactured by Rigaku Corporation) was used, and CuKα rays having wavelengths of 0.15405 nm and 0.15444 nm were used as an X-ray source. On the basis of the X-ray diffraction pattern obtained by the X-ray diffraction method, crystallinity Dc of the positive active material was determined from Scherrer's formula represented by the formula (1).

Dc=Kλ/(β cos θ) (1)

In addition, the crystallinity (or also referred to as crystallite size) was calculated by substituting the peak position and the integral width derived from a lattice plane (104) obtained from the measured X-ray diffraction spectrum into the Scherrer equation.

Li_{dis} indicates the existence ratio of the lithium element in the transition metal layer of nickel, cobalt, manganese, or the like having a layered structure in the lithium element of a lithium-nickel-cobalt-aluminum composite oxide. In the Li_{dis} calculation method, calculation is performed by the following procedure. Based on the obtained X-ray diffraction pattern, the composition model was set to (Li₁₋ₓ+Meₓ) (Li_{1-y}Me_{y}) O₂ (Me represents 1 mol % or more of the transition metal and aluminum in the lithium transition metal composite oxide, that is, Ni, Co, Mn, and Al in this example), and the lithium transition metal composite oxide was structurally optimized by Rietveld analysis using Rietan 2000 software. Here, assuming that the percentage of 1-y calculated as a result of the structure optimization is Li_{dis} and the percentage of x is Me_{dis}, the results obtained for a total amount of Li and Me are also shown in Table 2. Li_{dis} is correlated with the battery characteristics, and the lower Li_{dis} is, the better battery characteristics are exhibited.

The a-axis length and the c-axis length in the optimized crystal structure were obtained by the above-described Rietveld analysis. With the six rotation axes in the hexagonal system as the c-axis, the a-axis and the b-axis were assumed to be in a plane perpendicular to the c-axis, the angle formed by the a-axis and the b-axis was 120 degrees, and the a-axis and b-axis lengths were the same. The results are shown in Table 2.

A positive electrode was produced using the obtained positive electrode material. 92 parts by mass of the positive electrode active material, 3 parts by mass of acetylene black, and 5 parts by mass of polyvinylidene fluoride (PVDF) as a binder were dispersed in N-methyl-2-pyrrolidone (NMP) to prepare a slurry. The obtained slurry was applied to one surface of an aluminum foil, dried, then compression-molded with a press machine so that the density of the positive active material layer was 3.3 g/cm³, and cut so that the size was 15 cm² to obtain a positive electrode of Example 1. The density of the positive active material layer was calculated by dividing the mass of the positive active material layer by the volume of the positive active material layer obtained by measuring the thickness of the positive active material layer with a micrometer.

### (Production of Negative Electrode)

97.5 parts by mass of artificial graphite, 1.5 parts by mass of carboxymethyl cellulose (CMC) as a binder, and 1.0 part by mass of styrene-butadiene rubber (SBR) were dispersed in pure water to prepare a slurry. The obtained slurry was applied to a copper foil, dried, then compression-molded with a press machine so that the density of the negative active material layer was 1.6 g/cm³, and then cut so that the size was 16.64 cm² to obtain a negative electrode.

### (Preparation of Nonaqueous Electrolyte)

Ethylene carbonate (EC) and methyl ethyl carbonate (MEC) were mixed at a volume ratio of 3:7 to obtain a mixed solvent. Lithium hexafluorophosphate (LiPF₆) was dissolved in the obtained mixed solvent so as to have a concentration of 1 mol/L to prepare a nonaqueous electrolyte.

### (Assembly of Battery)

Lead electrodes were attached to the respective current collectors of the positive electrode and the negative electrode produced, and then vacuum drying was performed at 120° C. Next, a separator was disposed between the positive electrode and the negative electrode, and they were housed in a bag-shaped laminate pack. After the housing, vacuum drying was performed at 60° C. to remove moisture adsorbed to each member. After vacuum drying, the nonaqueous electrolyte solution was injected into the laminate pack and sealed to obtain a laminate-type nonaqueous secondary battery as an evaluation battery.

### (Measurement of Charge-Discharge Capacity)

The prepared evaluation battery was charged and discharged using a charge-discharge test apparatus (TOSCAT-3100, manufactured by Toyosystem Corporation). In Examples 1 to 11 and Comparative Examples 1 to 6, the measurement range of the voltage was 4.25 V to 2.5 V, the charge-discharge current was applied at a current value at the time of extracting a capacity of 0.1 C, after the voltage reached the set voltage, the current was flowed so as to keep the set voltage constant, and charging was terminated at the time when the current value reached a value corresponding to 0.005 C. In Examples 12 and 13 and Comparative Examples 7 and 8, the measurement range of the voltage was 4.3 V to 2.5 V, the charge-discharge current was applied at a current value at the time of extracting a capacity of 0.2 C, after the voltage reached the set voltage, the current was flowed so as to keep the set voltage constant, and charging was terminated at the time when the current value reached a value corresponding to 0.05 C. The discharge current was a current value at the time of extracting a capacity of 0.05 C. The obtained charge capacity, discharge capacity, and coulombic efficiency are shown in Table 2.

TABLE 2

| | | | | | | | | | | | charge | discharge | coulombic |
|---|---|---|---|---|---|---|---|---|---|---|---|---|---|
| | D₅₀ | BET | Crystallinity | Ni_{dis} | Li | Me | z-axis | c-axis | Li_{dis} | Me_{dis} | capacity | capacity | efficiency |
| | (μm) | (m²/g) | — | (%) | — | — | (Å) | (Å) | (%) | (%) | (mAh/g) | (mAh/g) | (%) |
| Example 1 | 11.1 | 0.49 | 347 | 2.487 | 1.027 | 0.973 | 2.877 | 14.217 | 4.817 | 2.113 | 231.8 | 200.9 | 86.7 |
| Example 2 | 7.2 | 0.84 | 505 | 1.847 | 1.030 | 0.970 | 2.876 | 14.214 | 4.307 | 1.538 | 234.1 | 211.0 | 90.1 |
| Example 3 | 10.6 | 0.58 | 536 | 1.703 | 1.032 | 0.968 | 2.876 | 14.216 | 4.532 | 1.372 | 232.0 | 208.8 | 90.0 |
| Example 4 | 9.6 | 0.42 | 487 | 2.019 | 1.033 | 0.967 | 2.876 | 14.216 | 4.870 | 1.657 | 231.8 | 204.2 | 88.1 |
| Example 5 | 11.4 | 0.62 | 466 | 2.748 | 1.027 | 0.973 | 2.877 | 14.217 | 4.973 | 2.364 | 231.3 | 204.7 | 88.5 |
| Example 6 | 10.3 | 0.51 | 454 | 1.609 | 1.041 | 0.959 | 2.875 | 14.212 | 5.299 | 1.242 | 231.0 | 205.8 | 89.1 |
| Example 7 | 8.8 | 0.77 | 497 | 1.084 | 1.048 | 0.952 | 2.874 | 14.207 | 5.467 | 0.728 | 226.8 | 207.9 | 91.7 |
| Example 8 | 13.5 | 0.58 | 536 | 0.586 | 1.059 | 0.941 | 2.872 | 14.206 | 6.112 | 0.214 | 227.7 | 206.1 | 90.5 |
| Example 9 | 8.7 | 0.59 | 553 | 1.197 | 1.051 | 0.949 | 2.873 | 14.210 | 6.166 | 0.812 | 226.3 | 203.9 | 90.1 |
| Example 10 | 10.5 | 1.74 | 355 | 2.439 | 1.033 | 0.967 | 2.876 | 14.215 | 5.319 | 2.043 | 228.4 | 205.6 | 90.0 |
| Example 11 | 9.2 | 1.63 | 571 | 1.844 | 1.041 | 0.959 | 2.876 | 14.215 | 5.309 | 1.445 | 229.1 | 199.2 | 87.0 |
| Example 12 | 17.2 | 0.39 | 475 | 1.161 | 1.049 | 0.951 | 2.874 | 14.222 | 5.680 | 0.793 | 230.7 | 197.3 | 85.5 |
| Example 13 | — | 0.48 | 507 | 1.282 | 1.050 | 0.950 | 2.875 | 14.221 | 5.874 | 0.887 | 230.2 | 199.8 | 86.8 |
| Comparative | 7.7 | 0.78 | 355 | 4.261 | 1.026 | 0.974 | 2.876 | 14.211 | 6.263 | 3.727 | 219.9 | 189.6 | 86.2 |
| Example 1 | | | | | | | | | | | | | |
| Comparative | 10.3 | 0.75 | 494 | 1.505 | 1.059 | 0.941 | 2.873 | 14.206 | 6.856 | 1.047 | 218.9 | 192.9 | 88.1 |
| Example 2 | | | | | | | | | | | | | |
| Comparative | 9.3 | 0.70 | 536 | 1.264 | 1.061 | 0.939 | 2.873 | 14.206 | 6.869 | 0.787 | 218.8 | 193.9 | 88.6 |
| Example 3 | | | | | | | | | | | | | |
| Comparative | 9.6 | 0.66 | 462 | 1.523 | 1.064 | 0.936 | 2.871 | 14.202 | 7.407 | 1.052 | 217.2 | 192.6 | 88.7 |
| Example 4 | | | | | | | | | | | | | |
| Comparative | 13.0 | 0.50 | 529 | 1.178 | 1.067 | 0.933 | 2.871 | 14.203 | 7.415 | 0.727 | 216.3 | 190.2 | 88.0 |
| Example 5 | | | | | | | | | | | | | |
| Comparative | 9.2 | 1.68 | 474 | 1.834 | 1.064 | 0.936 | 2.871 | 14.202 | 7.680 | 1.296 | 217.3 | 191.1 | 88.0 |
| Example 6 | | | | | | | | | | | | | |
| Comparative | 20.3 | 0.33 | 520 | 0.577 | 1.077 | 0.923 | 2.871 | 14.213 | 7.767 | 0.091 | 218.0 | 188.9 | 86.6 |
| Example 7 | | | | | | | | | | | | | |
| Comparative | 20.3 | 0.38 | 532 | 0.466 | 1.077 | 0.923 | 2.871 | 14.213 | 7.767 | 0.091 | 217.9 | 188.8 | 86.7 |
| Example 8 | | | | | | | | | | | | | |

In Examples 1 to 13 in which Li_{dis} was 6.2% or less, the charge capacity exceeded 226 mAh/g, whereas in Comparative Examples 1 to 8 in which Li_{dis} was greater than 6.2%, the charge capacity was 220 mAh/g or less. Regardless of the difference in the Ni ratio, the lower the Li_{dis}, the higher the charge capacity.

What is claimed is:

1. A positive active material for a lithium ion battery having a layered structure, the positive active material comprising nickel atoms and cobalt atoms,
wherein the positive active material has a ratio of a number of moles of the nickel atoms to a total number of moles of metal atoms other than lithium that is 0.7 or more and less than 1, and
wherein the positive active material has a disorder of lithium element determined by an X-ray diffraction method that is 6.2% or less.

2. The positive active material for a lithium ion battery according to claim 1, wherein a lattice constant of an a-axis in a crystal structure of the positive active material is 2.874×10⁻¹⁰ m or more.

3. The positive active material for a lithium ion battery according to claim 1, wherein the lattice constant of a c-axis in a crystal structure of the positive active material is 14.212×10⁻¹⁰ m or more.

4. The positive active material for a lithium ion battery according to claim 1, wherein the positive active material has a ratio of a number of moles of the cobalt atoms to the total number of moles of metal atoms other than lithium that is 0.05 or more and less than 0.2.

5. The positive active material for a lithium ion battery according to claim 1, wherein the positive active material has the ratio of the number of moles of the nickel atoms to the total number of moles of metal atoms other than lithium that is 0.80 or more and less than 0.95.

6. The positive active material for a lithium ion battery according to claim 1, further comprising manganese atoms,
wherein the positive active material has a ratio of a number of moles of the manganese atoms to the total number of moles of metal atoms other than lithium that is 0.05 or more and less than 0.2.

7. The positive active material for a lithium ion battery according to claim 1, further comprising aluminum atoms,
wherein the positive active material has a ratio of a number of moles of the aluminum atoms to the total number of moles of metal atoms other than lithium that is 0.01 or more and less than 0.1.

8. The positive active material for a lithium ion battery according to claim 1, wherein a specific surface area of the positive active material is 0.3 m²/g or more and 1.2 m²/g or less.
